(19) United States
(12) Patent Application Publication
(10) Pub. No.: US 2025/0380096 A1
(43) Pub. Date: Dec. 11, 2025

(54) EAR-WORN HEARING DEVICE WITH ELECTRICAL CONNECTOR

(71) Applicant: KNOWLES ELECTRONICS, LLC, ITASCA, IL (US)

(72) Inventor: MATTHEW MANLEY, CRYSTAL LAKE, IL (US)

(21) Appl. No.: 18/734,549

(22) Filed: Jun. 5, 2024

(51) Int. Cl. H04R 25/00; H01R 13/627

(52) U.S. Cl. CPC H04R 25/609; H01R 13/6272; H04R 25/604; H04R 25/65; H04R 2225/0216

(57) ABSTRACT

An ear-worn hearing device including a speaker and base units interconnected by an electrical connector are disclosed. The connector includes an electrical connector receptacle having multiple electrical contacts at least partially located in a metal plug socket defining a connector plug cavity. An electrical connector plug includes a plug body retaining multiple electrical contacts. Electrical contacts of the electrical connector plug are electrically connected to corresponding electrical contacts of the electrical connector receptacle when the plug body is inserted into the connector plug cavity. A gasket or complementary retention features on the plug body and plug cavity securely fasten the connector receptacle to the connector plug.

### FIELD OF THE DISCLOSURE

The present disclosure relates generally to hearing devices and more particularly to body-worn hearing devices comprising an electrical connector, electrical connectors for such hearing devices, and hearing device components comprising an electrical connector or portion thereof.

### BACKGROUND

Some ear-worn hearing devices comprise a speaker unit including a cable assembly connectable to a microphone unit by an electrical connector. One such hearing device comprises a receiver-in-canal (RIC) unit configured for at least partial insertion in the user's ear canal and a behind-the-ear (BTE) unit configured for wearing against a backside of the user's ear. The RIC unit comprises a balanced armature receiver (also referred to herein as a “receiver”) for converting electrical audio signals to sound. The BTE unit comprises a housing containing a battery, microphone, and electrical circuitry for converting sensed environmental sounds into amplified electrical audio signals. The electrical connector comprises an electrical connector plug coupled to the electrical cable assembly extending from the RIC unit. The connector plug is connectable to a plug receptacle of the BTE unit. Thus configured, electrical audio signals can be transmitted from the BTE unit to the RIC unit. The electrical connector must be relatively small, robust, accommodate an ever-increasing number of electrical contacts, prevent infiltration of contaminants, and reliably fasten the RIC unit to the BTE unit. However, existing hearing device electrical connectors are relatively large and costly and comprise plastic parts having short lifespans. Thus, there is an ongoing need for improvements in electrical connectors for body-worn hearing devices and combinations thereof.

### BRIEF DESCRIPTION OF THE DRAWINGS

The objects, features and advantages of the present disclosure will become more fully apparent upon consideration of the following detailed description and appended claims in conjunction with the accompanying drawings. The description and drawings depict representative embodiments and suggest others and are not considered to limit the scope of the disclosure.

FIG. 1 is a representative hearing device comprising an electrical connector.

FIG. 2 is a disassembled perspective view of a representative hearing device connector.

FIG. 3 is a disassembled sectional view of the hearing device connector of FIG. 2.

FIG. 4 is an assembled sectional view of the hearing device connector of FIG. 3.

Those of ordinary skill in the art will appreciate that the drawings are illustrated for simplicity and clarity and therefore may not be drawn to scale and may not include well-known features, that the order of occurrence of actions or steps may be different than the order described herein, that the order of occurrence of such actions or steps may be performed concurrently unless specified otherwise, and that the terms and expressions used herein have meaning understood by those of ordinary skill in the art except where a different meaning is specifically attributed to them herein.

### DETAILED DESCRIPTION

The present disclosure relates generally to hearing devices and more particularly to body-worn hearing devices comprising an electrical connector, electrical connectors for such hearing devices, and hearing device components comprising an electrical connector or portion thereof. In one application, the electrical connector interconnects a speaker unit and a base unit of an car-worn hearing device. One such application is for connecting a receiver-in-canal (RIC) component configured for at least partial insertion into the user's ear canal to a behind-the-car (BTE) unit configured for wearing on a back side of the user's ear. The electrical connectors described herein can also be connected to other hearing devices including ear buds and studio monitors among others. Representative examples are described herein.

Generally, a body-worn hearing device comprises a speaker unit and a base unit connected by an electrical connector. The connector includes a connector receptacle having multiple electrical contacts at least partially located in a metal plug socket defining a connector plug cavity. A connector plug includes a plug body retaining multiple electrical contacts. Electrical contacts of the electrical connector plug are electrically connected to corresponding electrical contacts of the electrical connector receptacle when the plug body is inserted into the connector plug cavity. A retention feature can securely fasten the connector receptacle to the connector plug. A seal between the plug cavity and the plug body provides a debris barrier and can securely fasten the connector receptacle to the connector plug in addition to or in lieu of the retention feature. Other implementations will be apparent from the representative embodiments described herein.

FIG. 1 is a representative ear-worn hearing device 100 generally comprising a speaker unit 110 connected to a base unit 120 by an electrical connector. An electrical cable assembly 130 extending from the speaker unit comprises a first electrical connector portion connectable to second electrical connector portion integrated with the base unit, as described further herein. The representative speaker unit is configured for at least partial insertion in the user's ear canal. Thus, the speaker unit can be considered an ear-worn unit. Such a speaker unit, alone or in combination with the electrical cable assembly, can be referred to as a receiver-in-canal (RIC) unit or component. The representative base unit is configured for wear on a back side of the user's ear and can be referred to as a behind-the-ear (BTE) unit or component. More generally, the speaker component can be any unit worn on, in or over the ear, and the base component can be any unit worn on or around a portion of the user's body, e.g., the ear, neck, arm, waist, leg or other body part.

In some hearing devices, the speaker unit is releasably connectable to the base unit by the electrical connector. A releasable electrical connector permits interchangeable use of different speaker units and cable assembly combinations with a common base unit. As such, combining speaker units having different power levels and different size cable assemblies can accommodate variations in user anatomy and amplification requirements when connected to the base unit. In other implementations, the speaker unit is permanently connected to the base unit via the electrical cable assembly.

The speaker unit generally comprises a speaker or receiver that generates an acoustic signal in response to an electrical audio signal provided by the base unit. The speaker unit can also comprise other electrical or mechanical hearing device parts. In FIG. 1, the representative speaker unit 110 comprises a receiver 112 having a sound port through a nozzle 113 coupled to a resilient ear dome 114 configured for at least partial insertion in a user's ear canal. A receiver generally comprises a diaphragm that separates an interior of a receiver housing into a back volume and a front volume acoustically coupled to a sound port. The receiver also comprises a motor, located in the receiver housing, including an armature movably located between permanent magnets of a yoke and connected to the diaphragm. The application of an electrical audio signal to the motor actuates the diaphragm to produce sound. Other speaker units can comprise multiple receivers, or a dynamic speaker, or a combination of one or more dynamic speakers and receivers.

In FIG. 1, the receiver housing constitutes an exterior of the speaker unit 110. The nozzle 113 is shown integrated directly with the receiver housing 112. For example, the nozzle can be fastened over the sound port on an end of the receiver housing. Thus configured, the speaker unit is devoid of any structure encapsulating the exterior of the receiver housing, reducing the overall size of the speaker unit. The motor can be directly coupled to an interior of the receiver housing without intervening structure, further reducing the overall size of the speaker unit. In other implementations, the receiver or speaker can be partially or fully encapsulated in an outer housing (not shown) and the nozzle can be integrally formed with the outer housing and acoustically coupled to the sound port of the receiver. The speaker unit can also include one or more microphones, vibration sensors, and physiological sensors, among other circuits and sensors fastened to the receiver housing or otherwise integrated with the speaker unit housing, depending on the form factor and use case.

In FIG. 1, the representative BTE base unit 120 generally comprises one or more microphones, an audio signal processor and other circuits, and a battery. Thus configured, the base unit can process acoustic audio signals detected by the one or more microphones and provide electrical audio signals to the speaker unit via the electrical cable assembly. More generally, the base unit can comprise other electrical or mechanical hearing device parts in lieu of, or in addition, to one or more microphones, processor and circuits, and battery. Such other parts can include but are not limited to a wireless transceiver, among other circuits and sensors.

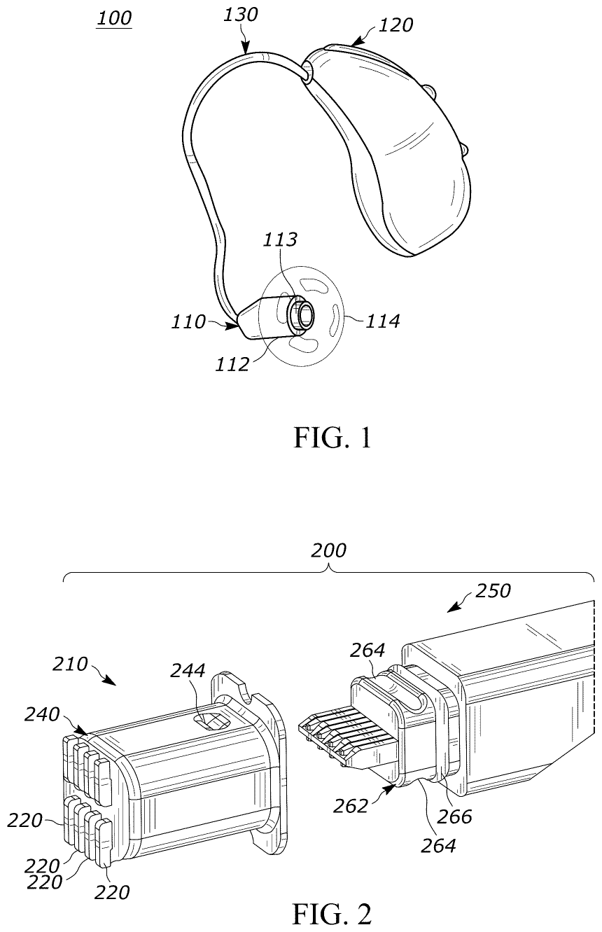

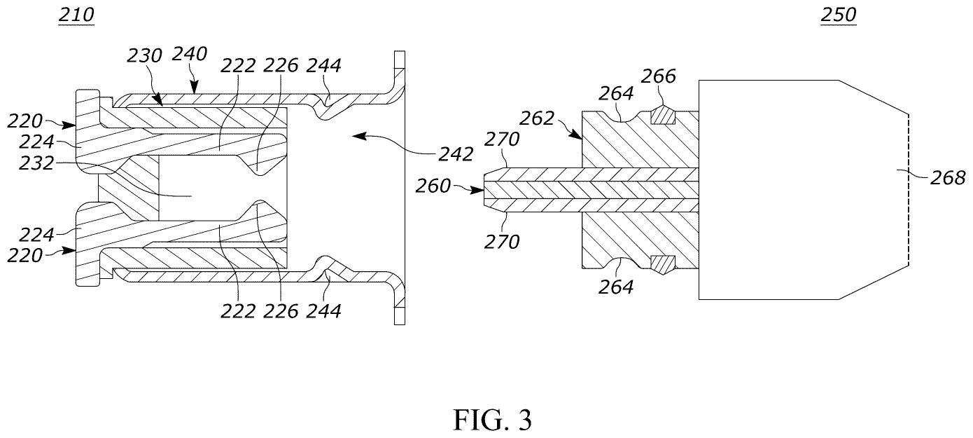

In FIGS. 2-4, an ear-worn hearing device connector 200 comprises an electrical connector receptacle 210 connectable to one of a speaker unit or a base unit, for example the RIC unit 110 or the base unit 120 of FIG. 1. The electrical connector receptacle generally comprises multiple electrical contacts at least partially located in a metal plug socket 240 comprising a connector plug cavity 242 best shown in FIG. 3. The metal can be conductive material to provide electromagnetic shielding and can be plated for corrosion resistance and for the ability to be wetted and mounted by molten solder. Optionally, the metal can also be a hypoallergenic metal like stainless steel, or it can be coated with a hypoallergenic coating. In FIG. 3, a first contact portion 222 of each electrical contact extends into the socket cavity 242, and a second contact portion 224 of each electrical contact is accessible from an exterior of the metal plug socket. The first contact portion 222 of each electrical contact can include a protrusion 226 for engagement of a complementary contact of an electrical connector plug described further herein.

The electrical contacts of the electrical connector receptacle can be electrically connected to electrical hearing device parts of the base unit or the speaker unit. When the electrical connector receptacle is integrated with a BTE unit, for example, at least some of the electrical contacts can be connected to the audio processor among other circuits or electrical parts. Alternatively, when the electrical connector receptacle is integrated with an electrical cable assembly connected to a RIC unit, at least some of the electrical contacts can be electrically connected to the receiver, speaker, or other electrical parts of the RIC unit via conductors of the cable assembly. In either case, such electrical connections can be made directly via the second contact portions 224 or via a circuit board (not shown) to which the second contact portions 224 are soldered.

In FIGS. 2-4, the ear-worn hearing device connector component 200 also comprises an electrical connector plug 250 connectable to the other of the speaker unit or the base unit. The electrical connector plug can comprise a contact carrier 260 protruding from a plug body 262 comprising a plastic or other non-conductive material. The connector plug retains multiple electrical contacts 270. The representative contact carrier 260 has a rectangular sectional shape and the multiple electrical contacts are spaced apart in parallel arrays on opposite sides of the contact carrier. In other implementations, the contact carrier can have a cylindrical or other sectional shape on which portions of the electrical contacts can be located. The electrical contacts can be retained by the plug body and contact carrier by insert-molding, over-molding or some other assembly process.

When the electrical connector plug is integrated with an electrical cable assembly connected to a RIC unit, for example, at least some of the electrical contacts are electrically connected to the receiver, speaker, or other electrical parts of the RIC unit via conductors of the cable assembly. Alternatively, when the electrical connector plug is integrated with a BTE unit, at least some of the electrical contacts are connected to the audio processor and among other circuits or electrical parts of the BTE unit. Such electrical connections can be made directly to the electrical contacts of the electrical connector receptacle or to a circuit board (not shown) to which portions of the electrical contacts are soldered. Such a circuit board can be embedded in a base portion 268 of the electrical connector plug.

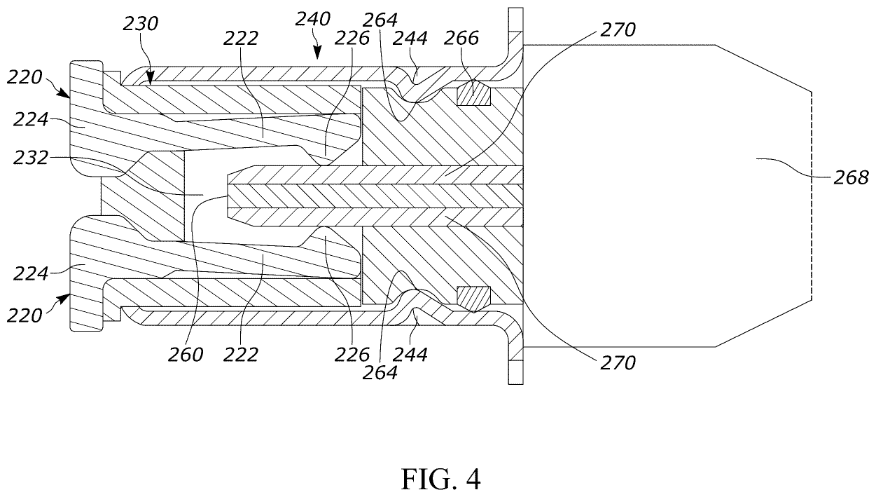

In FIG. 4, electrical contacts 270 of the electrical connector plug are electrically connected to electrical contacts 220 of the electrical connector receptacle when the plug body 262 of the connector plug is disposed in the plug cavity 242 of the connector plug receptacle. In the representative implementation, the contact protrusions 226 of the connector receptacle engage contacts 270 of the connector plug. In other implementations, the electrical contacts of the connector receptacle and connector plug can have different shapes or configurations. Thus configured, the BTE unit can communicate electrical audio signals to the RIC unit. More generally, in some implementations, electrical signals (e.g., control, data, etc.) can be communicated between the base unit and the speaker unit.

In some implementations, the electrical connector receptacle also comprises a retention feature integrally formed with the metal plug socket, and the plug body comprises a complementary retention feature, or vice-versa. The resilient nature of the metal plug socket or the plastic connector plug permit temporary deformation of one or both during assembly of the connector plug and the connector receptacle. Thus configured, the engaged retention features securely fasten the connector plug and the connector receptacle.

The retention feature can be implemented as a detent integral with the metal plug socket and the complementary feature can be a recess into which the detent fits upon assembly of the connector plug and connector receptacle. In the representative implementation of FIGS. 2-4, the retention feature of the connector receptacle 210 comprises one or more discrete protrusions 244 extending into the plug cavity from a wall portion of the metal plug socket. The complementary retention feature of the connector plug 250 comprises a corresponding number of recess 264 formed in the plug body 262. The metal plug socket and the retention feature can constitute a unitary deep-drawn article, which is cost effective and durable. Alternatively, the retention feature of the connector receptacle 210 can be a single circumferential protrusion disposed about the connector receptacle and the complementary retention feature can be a circumferential recess disposed about the plug body.

In FIGS. 3 and 4, the electrical connector receptacle comprises a non-conductive bushing 230 at least partially located in the metal plug socket 240. The non-conductive bushing flexibly retains the multiple electrical contacts at least partially in the plug cavity of the connector receptacle. The representative non-conductive bushing 230 comprises a recess 232 forming a portion of the connector plug cavity. The representative recess 232 has a rectangular sectional shape. In FIG. 2, the multiple electrical contacts 220 of the electrical connector receptacle comprise a first contact array located on a first side of the recess and a second contact array located on a second side of the recess. Each electrical contact of the first contact array is located opposite a corresponding electrical contact of the second contact array. In FIG. 4, the contact carrier 260 of the plug body and the contacts 270 are located at least partially in the recess 232 of the non-conductive bushing when the plug body is inserted into the connector plug cavity. Thus configured, each electrical contact 270 of the connector plug is electrically connected to a corresponding electrical contact 220 of the connector receptacle when the plug body is inserted into the plug cavity. In other implementations, the recess of the non-conductive bushing can have a cylindrical or other sectional shape on which the electrical contacts can be located for contacting electrical contacts of a plug body having a contact carrier with a complementary shape.

In one implementation, there is a gap between the bushing 230 and the contact portion 222 to permit flexing of at least the portion of the contact from which the protrusion 226 extends upon engagement with electrical contacts 270 of the connector plug. In other implementations, the non-conductive bushing is resilient to permit flexing of the electrical contacts. The non-conductive bushing 230 can be interference-fit into the metal plug socket 240. Alternatively, the bushing can be retained in the metal plug socket by crimping or glue, among other known or future fastening mechanisms.

In some implementations, the electrical connector receptacle optionally comprises a gasket configured to form a seal between the electrical connector plug and the electrical connector socket when the plug body is inserted into the plug cavity. In the representative implementation of FIGS. 3-4, a gasket in the form of a resilient ring 266 is disposed in a recess about the plug body 262. In FIG. 1, the plug body has a rectangular shape, but in other embodiments the plug body can have a round or oval shape. The resilient ring can be an O-ring having a circular cross section, a D-ring having a D-shaped cross section, or a ring having some other sectional shape. In FIG. 4, the resilient ring is compressed between the plug body 262 and an inner surface of the plug cavity 242 to form a moisture and debris barrier between the connector receptacle and the connector plug. The representative gasket 266 is located more near the plug cavity opening than the detent 224. In some implementations, the gasket may provide sufficient friction to retain the connector plug in the connector receptacle without a need for the retention features described herein. The metal plug socket can also comprise a recess (not shown) in the plug cavity to partially accommodate the gasket. Such a recess on the metal plug socket may improve both the sealing and retention function of the gasket. Thus, the gasket can be used alone or in combination with the retention feature to securely fasten the connector plug to the connector receptacle.

While the disclosure and what is presently considered to be the best mode thereof has been described in a manner establishing possession and enabling those of ordinary skill in the art to make and use the same, it will be understood and appreciated that there are many equivalents to the representative embodiments described herein and that myriad modifications and variations may be made thereto without departing from the scope and spirit of the invention, which is to be limited not by the embodiments described, but by the appended claims and their equivalents.

What is claimed is:

1. An ear-worn hearing device connector comprising:
an electrical connector receptacle connectable to one of a speaker unit or a base unit, the electrical connector receptacle comprising multiple electrical contacts at least partially located in a metal plug socket comprising a connector plug cavity, the electrical connector receptacle comprising a retention feature integrally formed on a wall portion of the metal plug socket; and
an electrical connector plug connectable to the other of the speaker unit or the base unit, the electrical connector plug comprising a plug body retaining multiple electrical contacts, the plug body comprising a complementary retention feature,
wherein electrical contacts of the electrical connector plug are electrically connected to corresponding electrical contacts of the electrical connector receptacle and the retention feature is engaged with the complementary retention feature when the plug body is inserted into the connector plug cavity.

2. The hearing device connector of claim 1, wherein the retention feature is a detent protruding into the connector plug cavity and the complementary retention feature is a recess in the plug body.

3. The hearing device connector of claim 2, the metal plug socket and the detent constitute a unitary deep-drawn article.

4. The hearing device connector of claim 1, the electrical connector receptacle further comprising a non-conductive bushing flexibly retaining the multiple electrical contacts in the connector plug cavity.

5. The hearing device connector of claim 4, wherein the complementary retention feature is a recess in the plug body and the retention feature is a detent protruding into the connector plug cavity, the detent and the metal plug socket constitute a unitary deep-drawn article.

6. The hearing device connector of claim 5 further comprising a gasket disposed about the plug body and located between the connector plug cavity and the plug body when the electrical connector plug is connected to in the electrical connector receptacle.

7. The hearing device connector of claim 6,
the non-conductive bushing comprising a recess forming a portion of the connector plug cavity, the multiple electrical contacts located on a portion of the non-conductive bushing defining the connector plug cavity,
the electrical connector plug comprising a contact carrier protruding from the plug body and retaining the multiple electrical contacts of the electrical connector plug,
wherein electrical contacts of the electrical connector plug are electrically connected to corresponding electrical contacts of the electrical connector receptacle when the contact carrier protruding from the plug body is inserted into the recess of the non-conductive bushing.

8. The hearing device connector of claim 1 in combination with a base unit comprising a housing containing a microphone connected to an electronic circuit, wherein the electrical connector receptacle is integrated with the housing of the base unit and electrical contacts of the electrical connector receptacle are electrically connected to the electronic circuit.

9. The hearing device connector of claim 8 in combination with a speaker unit comprising housing connected to an electrical cable assembly, the housing of the speaker unit containing a sound-producing transducer, the electrical connector plug connected to the electrical cable assembly, wherein the sound-producing transducer is electrically connected to electrical contacts of the electrical connector plug via conductors of the electrical cable assembly.

10. An ear-worn hearing device connector comprising:
an electrical connector receptacle connectable to one of a speaker unit or a base unit, the electrical connector receptacle comprising multiple electrical contacts flexibly retained by a non-conductive bushing at least partially located in a metal plug socket comprising a connector plug cavity;
an electrical connector plug connectable to the other of the speaker unit or the base unit, the electrical connector plug comprising a plug body retaining multiple electrical contacts; and
a gasket disposed about the plug body,
wherein electrical contacts of the electrical connector plug are electrically connected to corresponding electrical contacts of the electrical connector receptacle and the gasket forms a seal between the plug body and the connector plug cavity when the plug body is inserted into the connector plug cavity.

11. The hearing device connector of claim 10,
the non-conductive bushing comprising a recess forming a portion of the connector plug cavity, the multiple electrical contacts located on a portion of the non-conductive bushing defining the connector plug cavity,
the electrical connector plug comprising a contact carrier protruding from a plug body and retaining the multiple electrical contacts,
wherein electrical contacts of the electrical connector plug are electrically connected to corresponding electrical contacts of the electrical connector receptacle when the contact carrier is inserted into the recess of the non-conductive bushing.

12. The hearing device connector of claim 11 in combination with a base unit comprising a housing containing a microphone connected to an electronic circuit, wherein the electrical connector receptacle is integrated with the housing of the base unit and electrical contacts of the electrical connector receptacle are electrically connected to the electronic circuit.

13. The hearing device connector of claim 12, the electrical connector receptacle further comprising a detent protruding from a wall portion of the metal plug socket and into the connector plug cavity, and the electrical connector plug further comprising a recess into which the detent extends when the plug body is inserted into the connector plug cavity, wherein the detent and recess cooperate to securely fasten the electrical connector plug to the electrical connector receptacle.

14. The hearing device connector of claim 13, the metal plug socket and the detent constitute a unitary deep-drawn article.

15. The hearing device connector of claim 12 in combination with a speaker unit comprising a housing connected to an electrical cable assembly, the housing of the speaker unit containing a sound-producing transducer, the electrical connector plug connected to an end portion of the electrical cable assembly, wherein the sound-producing transducer is electrically connected to electrical contacts of the electrical connector plug via conductors of the electrical cable assembly.

16. A hearing device component comprising:
a body-worn unit comprising a housing containing electrical or mechanical hearing device parts; and
an electrical connector receptacle connected to the body-worn unit and comprising:
a metal plug socket comprising a plug cavity proximate an opening of the metal plug socket, and a detent protruding from a wall portion of the metal plug socket into the plug cavity; and
multiple electrical contacts, a first contact portion of each electrical contact extending into the plug cavity, and a second contact portion of each electrical contact accessible from an exterior of the metal plug socket.

17. The hearing device component of claim 16, wherein the metal plug socket and the detent constitute a unitary deep-drawn article.

18. The hearing device component of claim 17 further comprising a non-conductive bushing disposed in the metal plug socket, the multiple electrical contacts flexibly retained by the non-conductive bushing, the non-conductive bushing comprising a recess forming a portion of the plug cavity, the multiple electrical contacts retained by the non-conductive bushing adjacent the recess.

19. The hearing device component of claim 18, the body-worn unit is a behind-the-ear (BTE) unit, the hearing device parts comprising a microphone connected to an electronic circuit, wherein the electrical connector receptacle is integrated with the housing and electrical contacts of the electrical connector receptacle are electrically connected to the electronic circuit.

20. The hearing device component of claim 18, the body-worn unit is a receiver-in-canal (RIC) unit further comprising an electrical cable assembly extending from the housing, the hearing device parts comprising a sound-producing transducer, the electrical connector receptacle connected to the electrical cable assembly, wherein the sound-producing transducer and electrical contacts of the electrical connector receptacle are electrically connected to conductors of the electrical cable assembly.
